(19) United States
(12) Patent Application Publication
(10) Pub. No.: US 2019/0317810 A1
(43) Pub. Date: Oct. 17, 2019

(54) Network Infrastructure performing Distributed Computational Processing and Providing Secure and Encrypted Connection to the Internet

(71) Applicants: Tri Nguyen, Houston, TX (US); Michael Shader, Houston, TX (US)

(72) Inventors: Tri Nguyen, Houston, TX (US); Michael Shader, Houston, TX (US)

(21) Appl. No.: 15/953,348

(22) Filed: Apr. 13, 2018

(51) Int. Cl. G06F 9/50; G06F 11/30; G06Q 20/06

(52) U.S. Cl. CPC G06F 9/505; H04L 63/0428; G06Q 20/065; G06F 11/3062

(57) ABSTRACT

The present innovation is comprised of a software implemented network utilizing public/private key pairs to encrypt all data coming or going to the network for privacy protection, and centralizing all public data to and from the network so information cannot be associated back to a particular user, where the software implemented network is supported by utilization of the user's spare or unused computing processor power for Distributed Computation Processing to solve reward based problem. Further, the software updates the Distributed Computation Processing software and assignments with each network connection ensuring all connected parties are in cooperation and the system may be re-tasked with minimal to no interaction by participants. In preferred embodiments, the process for assigning computing devices that are connected to the Software Implemented Network or Virtual Private Network to perform Distributed Computational Processing or Mine for Cryptocurrency follow the illustrated procedure.

### BACKGROUND OF THE INVENTION

### Cross-Reference to Related Applications

This application claims priority under 35 U.S.C. §119(e) from co-pending U.S. Provisional Patent Application No. ##/###,###, by Tri Nguyen and Ralph Alan Harris, Jr., “NETWORK INFRASTRUCTURE PERFORMING DISTRIBUTED COMPUTATIONAL PROCESSING AND PROVIDING SECURE AND ENCRYPTED CONNECTION TO THE INTERNET” filed Apr. 12, 2017, which, by this statement, is incorporated herein by reference for all purposes.

### Background of the Invention

Networks enable the average person to connect to the Internet with little effort. Most people in the developed world have access almost constantly to multiple computing devices. Many are idling, or fully on and wasting cycles so they may be ready at a moment's notice to handle the commands of their users.

Desktops computers, turn off their screens, power down hard drives, and may even lower fans to reduce power. Some show pretty pictures, display time and weather, play zero player games, or otherwise perform useless “busy work” that keeps the machine in a constant state of readiness.

Computing devices include, but is not limited to: Servers, desktop computers, laptops, tablets, E-readers, watches, even many appliances are not including basic computing functionality. All of the listed computing devices have a Central Processing Unit (CPU), and many also have a Graphics Processing Unit (GPU). These two devices are central to a computer to be able to carry out the instructions of a computer program and rapidly manipulate and alter memory to create images in a frame buffer to output to a display device, respectively.

Computers and mobile devices continue to become exponentially more powerful, with increased computational power, the processing power required to perform normal daily tasks has seen a relatively small increase. Thus, most end consumers do not require a majority of their processing power at any given time, leaving a large potential of underutilized pool of processing power.

These computing machines often have reliable, regular, sometimes constant access to the Internet, and regularly utilize it to receive short messages, get mail, update statuses, received reminders, software update notices, news, etc. The computing machines also often send messages confirming actions, checking with a monitor, requesting messages and/or information, or sending usage statistics to companies monitoring phone, printer, computer usages, and other activity many people may prefer not be monitored.

Historically - there has been little to no encryption and security measures in place to protect the data that is being transferred back and forth between the user's computer to the end server. This means that the connection is easily intercepted. Companies and individuals routinely monitor many user's online activity.

With the evolution of Internet tracking tools, random packets of user data now turn into identifiable packets of personal information, tracking search history, browsing habits, shopping routines, purchasing preferences, and communications previously thought to be private, all are not only available, but attributable back to specific individuals. The use of identifiable user data allows big data companies, Internet service providers, and advertising/marketing agencies to sell and exchange your data and to make a profit from the information. Even governments can utilize the information to determine activity and scrutinize for illegal, subversive, or generally undesirable activity. Calendars, Travel plans, even actual physical locations are available to those interested. All of this data has value as it helps to understand the user/person, and their intentions. Businesses are also interested in more general activity to assist in classifying, and understanding or possibly predicting behavior others in similar demographics: i.e. age, sex, race, financial means, occupations, etc.

One way to prevent monitoring of computing device usage is the use encryption and use of other security measures to block data. By effectively scrambling the data for anyone not privileged enough to have the means to unscramble a user can render that data useless to everyone except the intended recipient. Encryption with public/private key pairs allows this activity, but requires time and effort to run cyphers, so this method is not used unless high security is required.

Another method of preventing monitoring is to “hide in the crowd.” By redirecting all of a user's data through common portals (hereinafter “Tunnels”) used by many others, a user can obscure the source of data, thus making the data less valuable to those seeing it when devoid of demographic associations. Encryption is now needed only for the communications between the user's location to and from the Tunnels.

Network Infrastructures exist to protect user privacy, by encrypting packets of data being transferred from the user's connection to the Tunnel leading out to the open Internet. Network Infrastructures have both hardware and software implementations. Users can own private physical hardware servers, or use Software Implemented Network to reroute their connection through an encrypted connection Tunnel.

However, the process of setting up and running a personal Network Infrastructure can be technically challenging and expensive for average users who simply do not have the technical capabilities or resources to implement such a solution.

In the recent years, new Network Infrastructures have been introduced in the market to allow Users to plug in a new hardware server and install hardware-specific software to activate, or even simply install end user software to connect through a Software Implemented Network with a click of a button through a software graphical user interface. These new services and products allow users to safely connect through secure Tunnels to the open Internet at a minimal cost.

Other services may allow a user free access to their service, but the reality is that connection comes at the cost of losing true end to end encryption and privacy. Most of these free service providers make their income by selling the data of their users to the highest bidder or selling the bandwidth of the users to others connected to the Software Implemented Network.

A far worse problem is when some Software Implemented Network services allow other users of the Software Implemented Network to share a user's Internet Protocol, which is their identifiable digital footprint in the Network. This means others can conduct illegal or questionable activities on the Internet which can be traced back to the incorrect, innocent, and unsuspecting user.

Computational Processing has generally been done on singular devices, servers, or enclosed networks. Distributed Computational Processing (DCP) is the process of utilizing the computing power throughout a Network Infrastructure to spread the workload throughout the Network Infrastructure. A good metaphor is taking an entire puzzle and giving hundreds or thousands of computers small quadrants of the puzzle to solve by having each computer look for specific pieces that fit in ‘their’ quadrant. By breaking up a large problem to solve into many different quadrants, the puzzle gets solved quicker as the number of computers within the Network Infrastructure increases the number of solutions being attempted per second.

A common use of DCP is in the mining of cryptocurrency. Cryptocurrencies are digital decentralized currency which use cryptography as a means to create, transact, and verify utilization. Each cryptocurrency has a unique method that defines its existence and how it operates. However, a general common theme requires that the network maintain a public ledger in which new transactions are checked and verified by other members of the network via cryptography. This process is often referred to as mining, due to the association of a reward in the form of newly minted cryptocurrency when a mining operation is complete or solved. Verified transactions and newly created cryptocurrency are documented in the public ledger of each cryptocurrency. Public ledgers serve as an official record of all transaction that happened since the inception of the currency.

Cryptocurrency Mining generally requires the utilization of physical computational hardware, often CPUs and GPUs of multiple computers. Borrowing from the analogy of the puzzle above, these multiple computers are tasked with attempting to fit every single puzzle piece to a single position and does not stop until a puzzle piece is located which fits in the position. Then the computer moves on to the next position and tries to fit every single puzzle piece into the new position, omni loco. Once the puzzle is completed, a reward is earned.

### BRIEF DESCRIPTION OF THE DRAWINGS

FIG. 1 illustrates a typical network configuration with internal network components and remote Internet connected components in accordance with an exemplary embodiment of the innovation.

FIG. 2 depicts a flowchart of how a Network Infrastructure supports various embodiments of the innovation.

FIG. 3 Shows a flowchart demonstrating the process in a Network Infrastructure to determine and utilize unused processing power to perform Distributed Computational Processing in accordance with an exemplary embodiment of the innovation.

FIG. 4 depicts a simplified cryptocurrency mining process using Bitcoin as demonstrative of various embodiments in accordance with exemplary embodiment of the innovation.

### BRIEF SUMMARY OF THE PREFERRED EMBODIMENTS

Described herein is a method of utilizing unused processing power in computing devices to perform Distributed Computational Processing (“DCP”) within a Network Infrastructure (“NI”), while providing secure and encrypted access to the Internet. When a user connects to a Network Infrastructure, which can be implemented either in Hardware or Software form, the computing device's excess computational power is determined. In one embodiment, connecting to a Network Infrastructure may comprise connecting to a carrier, or an ISP's (Internet Service Provider) physical network, or dialing into a modem to connect to a hub, router, or switch. In another embodiment, connecting to a Network Infrastructure may comprise connecting to a Virtual Private Network (a “VPN”). The Network Infrastructure provides encrypted and secure access to the Internet and simultaneously assigning a portion of unused computational power for the computing device to the NI's DCP for assignment of Computational Processing operations. The present innovation may utilize additional methods for determination of unused processing power. One skilled in the art would appreciate that temperature of the hardware, fan speed, memory usage, operating system cycle count, etc. are all measurements which may be correlated with processor usage and may be used for determination of computational processing power.

### DETAILED DESCRIPTION OF THE PREFERRED EMBODIMENTS

A single computing device would make little progress on complex mathematical problems of the general magnitudes contemplated by this application. However, multiple computing devices coordinated by an administrative system and sharing a Network Infrastructure can converge on a solution in a more reasonable time by combining their computing power. This results in a faster solution time and in the applicant's innovation, this results in any rewards earned for solutions being divided among the participants pro-rata.

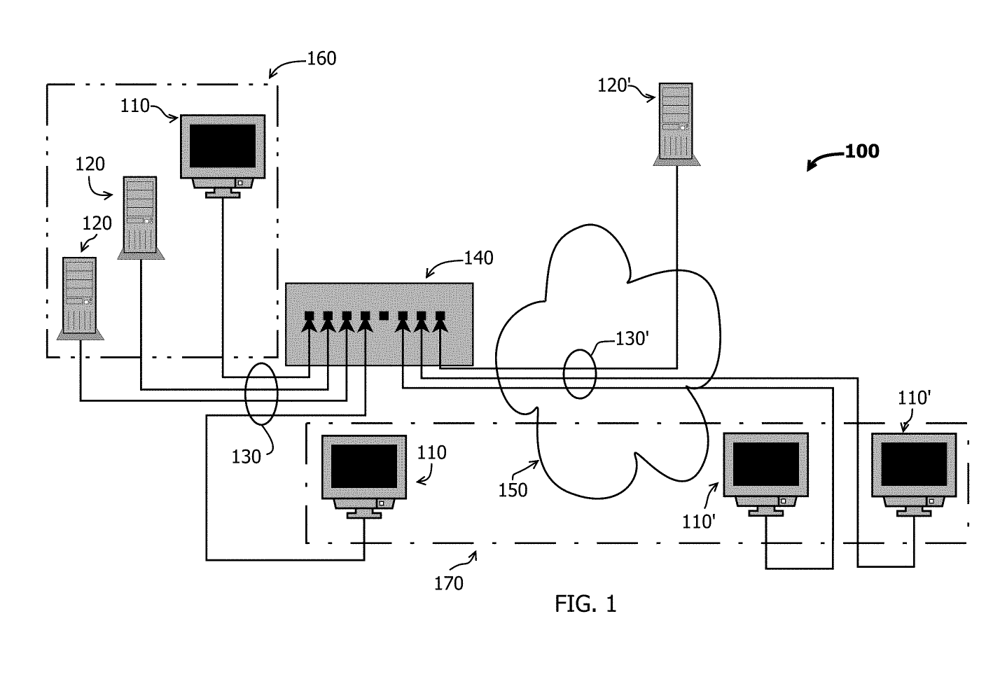

FIG. 1 illustrates a typical network configuration with internal network components and remote Internet connected components in accordance with an exemplary embodiment of the innovation. Local client machines (110) and remote client machines (110′) are illustrated with local server machines (120) and remote server machines (120′) connected, some through local hardwire (130), and some through remote connections such as the Internet (150) connections (130′), to one or more multiport switch/router/hubs (140) to product a Network Infrastructure (100).

In the illustration, devices have been represented as segmented into two virtual Network Infrastructures: a first (160) comprising all local machines (110, 120) and a second (170) comprising both local (110 & 120 [not shown] and 110′ & 120′ [not shown]).

One skilled in the art would appreciate that hardware can create separate Network Infrastructures by physically configuring the wiring (130, 130′) of networked devices to one or more interconnected multiport switches/routers/hubs (140).

One skilled in the arts would also appreciate that software can create separate Virtual Network Infrastructures by configuring devices to only recognize and work with other machines designated as connected to their virtual network infrastructure.

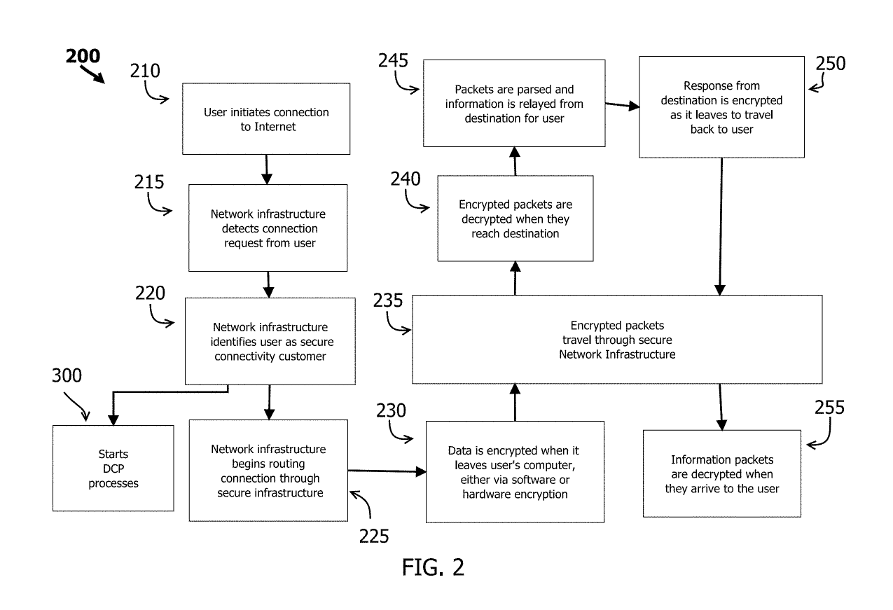

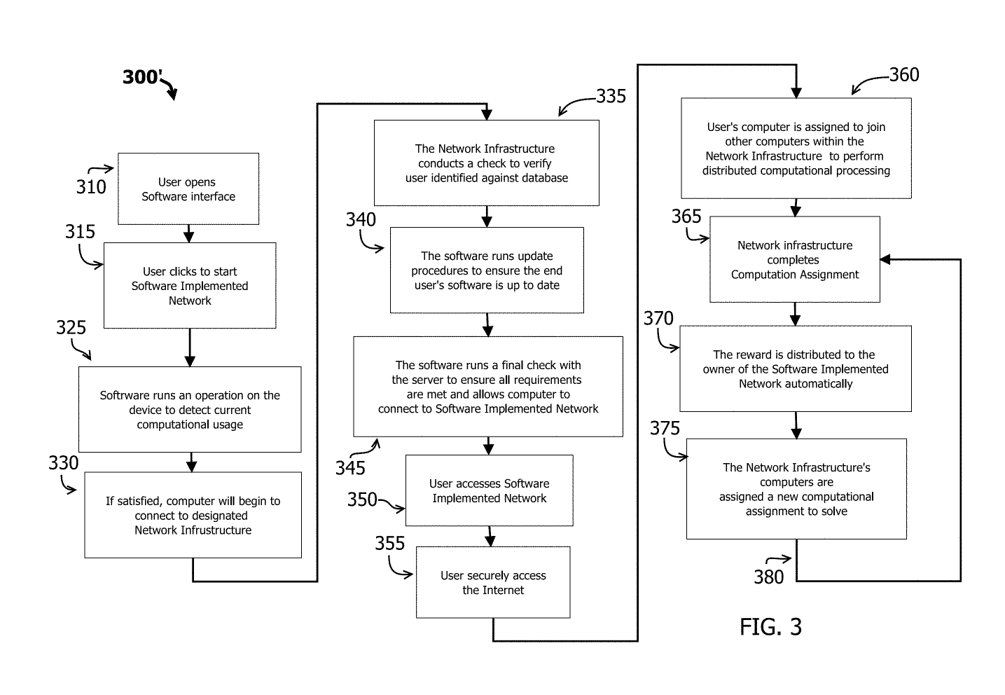

FIG. 2 depicts a flowchart of how a Network Infrastructure supports various embodiments of the innovation. The flowchart (200) begins with a user's computing device initiating an Internet Connection (210). Note: this may be accomplished through software as described in 310 and 315 on FIG. 3

The Network Infrastructure receives the connection request (215), and, authenticates the user's credentials (220) to identify the user as a secure connectivity user. After authentication, the user's connection begins routing all communication packets through the secure infrastructure (225). Further, a secondary process is started as shown to start DCP processes (300, see FIG. 3).

To ensure end-to-end encryption to prevent any network intruders from deciphering and breaking the encryption, both the end user and the receiving destination have decryption keys. The data is encrypted when it leaves the user's computer, either through software or hardware encryption (230), and travels through the secure Network Infrastructure (235).

As the packets reach the destination they are decrypted (240), the destination parses the information to receive information from the user (245). When the destination is ready to send information back to the user, it begins by encrypting the packets of data (250) and sending the encrypted packets back through the secure Network Infrastructure to the user's computer (235), which is finally decrypted using the user's computer's decryption key when they arrive (255).

FIG. 3. Shows a flowchart demonstrating the process in a Network Infrastructure to determine and utilize unused processing power to perform Distributed Computational Processing in accordance with an exemplary embodiment of the innovation.

The flowchart (300′) expands on the element 300 from FIG. 2 which states “Starts DCP processes.” In this embodiment, the user utilizes a Software Implemented Network, which may also encompass a Virtual Private Network as illustrated in FIG. 2 described above. In the preferred embodiment, Distributed Computational Processing may also encompass Cryptocurrency mining.

After a user downloads and installs software on their computing device, they are able to access a Graphical User Interface (310) to connect to a Software Implemented Network (315). The user's computing device begins a hardware evaluation to detect current usage of the GPU and/or CPU to set an initial benchmark (325). The computing device runs benchmark diagnostics, ensuring that the device is within reasonable operational benchmarks compared to other devices in the same computing class (330), the software will connect to the Network Infrastructure. If the computer exceeds safety benchmark precautions, the user will be notified.

Upon connection to the Network Infrastructure (330) the system checks and confirms the user's information with that provided during registration (335). The software runs an update procedure to configure the user's Software Implemented Network for the purpose of being up-to-date (340). This updates security protocols, mining instructions, or any sort of instructions that relate to update of the software and computational direction for the computing device.

A final diagnostic check is run to make sure all updates are completed correctly and to ensure that the user's device did not download any malicious software in the process (345). After the final check, the computer connects the user to the Software Implemented Network (350), which allows the user to securely access the Internet and encrypts all outgoing and incoming data packets (See description of FIG. 2, above).

In the background while the user is using the Software Implemented Network to securely access the Internet (355, 200), their computational device joins other computers in the Network Infrastructure (360) to perform Distributed Computational Processing based on instructions that were downloaded during the Software Update (340). When the Network Infrastructure completes the Computational Assignment (365), which results in a reward or transaction fee, the reward is distributed directly to the owner of the Network Infrastructure (370). The Network Infrastructure assigns computers to begin solving a new computational assignment (375). The process repeats itself (380) until the user terminates the connection with the Software Implemented Network.

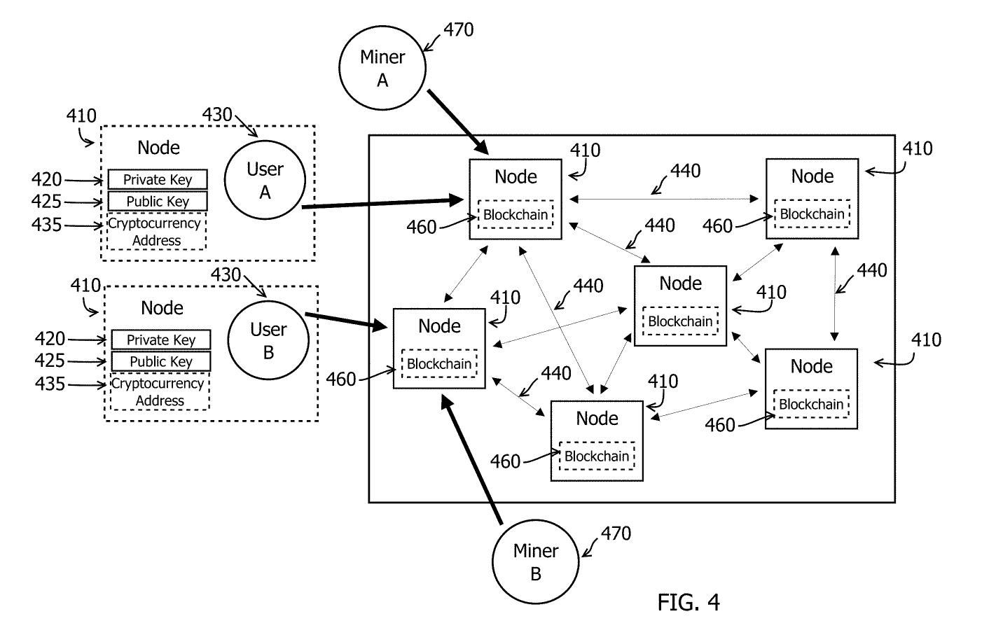

FIG. 4 depicts a simplified cryptocurrency mining process using Bitcoin as demonstrative of various embodiments in accordance with exemplary embodiment of the innovation. This diagram is meant to be simplified and to present a broad overview of a typical Cryptocurrency network (400), of which Bitcoin is used in this example. However, the end process can be used for any form of cryptocurrency that mining is involved in. The cryptocurrency network is made out of interconnected clients or (410) referenced as Nodes, which are responsible for validating any transaction that goes on in the network. A Node is comprised of generally four elements, shown as a Private Key (420), a Public Key (425), a User (430), and a Cryptocurrency Address (435).

The Public Key (425) is a cryptographic key that anyone who wants to encrypt a message, transaction, or data, can use to perform encryption on the outgoing data. The Private Key (420) is only known to the recipient and used to decipher and decrypt the message. The Cryptocurrency address (435) acts as a digital address for other users to perform transactions with other users. As a user (430) conducts a transaction with another user, the information gets encrypted. Once the node (410) is validated, the nodes (410) broadcast the transaction to all the nearby nodes (440), until every single node (410) has the same identical copy of it.

Rather than storing every single transaction in the current state and having millions of individual transactions that require constant update, the transactions are bundled into a Block (450, not illustrated). Once a Block is created, it will notify all other nodes (410) within the network to update their own Blockchain (460), which serves as a thread of every single Block since the inception of the coin.

(470), the Miners, are the nodes that perform the task of verifying the blocks and transactions. The speed in which they complete the process is determined by the computational power. Completed and processed Blocks often reward a Transaction Fee to the miner that completes the process.

It is important to understand that as user connect to the network, their software is updated, and their task are assigned. Therefore, different connected nodes may be working different task. Multiple task can be load balanced by monitoring the production levels of existing task and which task are being completed at what speed. In one embodiment some Nodes may be tasked as miners, and other are tasked for different purposes. In another embodiment, all nodes are tasked as miners. In another embodiment nodes are tasked as miners on different currencies, or on different blockchain problems not associated with currencies. In one embodiment monitoring software may re-task a node when a task is complete. In another embodiment a node retains the same problem but may be re-tasked by being assigned different areas of the problem. The purpose is to aggregate Nodes for computationally intensive research task. Such task may involve Blockchain for Cryptocurrencies as described here, but one skilled in the arts would appreciate that other computationally intensive research task exist such as, but not limited to: Machine learning, Deep learning, neural Network.

The flow diagrams in accordance with exemplary embodiments of the present innovation are provided as examples and should not be construed to limit other embodiments within the scope of the innovation. For instance, the blocks should not be construed as steps that must proceed in a particular order. Additional blocks/steps may be added, some blocks/steps removed, or the order of the blocks/steps altered and still be within the scope of the innovation. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the innovation.

The above discussion is meant to be illustrative of the principles and various embodiments of the present innovation. Numerous variations and modifications will become apparent to those skilled in the art once the above disclosure is fully appreciated. It is intended that the following claims be interpreted to embrace all such variations and modifications.

What is claimed is:

1. A method for distributed computational processing comprising:
having a monitoring computing device, (a monitor) and one or more additional computing devices forming, and each being a node on a network;
being a node comprising:
connecting to the network,
registering with the monitor as a member of the network,
assessing unused cycles of the node's computing power, and
reporting the unused computing power to the monitor;
the monitor solving a complex problem by:
dividing the problem into a plurality of sub-problems;
assigning nodes sub-problems to solve;
collecting solutions to sub-problems;
assembling the solutions into a single problem solution;
reporting the single problem solution.

2. The method described in claim 1 wherein the monitor solving a complex problem further comprises collecting a reward for reporting the single problem solution.

3. The method described in claim 2 further comprising:
the monitor, dividing the reward between the nodes from which solutions to sub-problems were collected.

4. The method described in claim 1 further comprising the nodes utilizing network resources independent of solving sub-problems.

5. The method described in claim 1 further comprising the monitor detecting a node disconnecting from the network and reassigning the sub-problem of the node to another node.

6. The method described in claim 3 further comprising:
the monitor, dividing the reward between the nodes from which solutions to sub-problems were collected proportionately to the quantity of the sub-problems collected from each node.

7. The method described in claim 3 further comprising:
the complex problem being the mining of cryptocurrency, where the sub-problem is a range of solutions to be attempted by the node.

8. The method described in claim 7 wherein the cryptocurrency is bitcoin.

9. The method described in claim 3 wherein assessing unused cycles of the nodes computing power comprises estimating processor utilization from processor temperature.

10. The method described in claim 3 wherein assessing unused cycles of the nodes computing power comprises estimating processor utilization from power consumption.

11. The method described in claim 3 wherein assessing unused cycles of the nodes computing power comprises polling the operating system's core processes which allocate the processing cycles.

12. The method described in claim 4 wherein utilizing network resources comprises:
the node encrypting messages;
the node sending encrypted messages to the network;
the network forwarding the messages to a destination;
the network receiving a response from the destination;
the network returning the response to the node;
the node receiving the response;
the node decrypting the response.

13. The method described in claim 4 wherein encrypting and decrypting is performed by a public/private key pair.
